(19) United States
(12) Patent Application Publication
(10) Pub. No.: US 2025/0207003 A1
(43) Pub. Date: Jun. 26, 2025

(54) TWO COMPONENT COMPOSITION BASED ON A BLEND OF EPOXIDE COMPOUNDS

(71) Applicant: Henkel AG & Co. KGaA, Duesseldorf (DE)

(72) Inventors: Chunfu Chen, Kanagawa Prefecture (JP); Shuichi Iwasaki, Kanagawa Prefecture (JP); Masao Kanari, Kanagawa Prefecture (JP); Daoqiang Lu, Shanghai (CN)

(21) Appl. No.: 19/070,611

(22) Filed: Mar. 5, 2025

Related U.S. Application Data
(63) Continuation of application No. PCT/CN2022/117013, filed on Sep. 5, 2022.

(51) Int. Cl. C09J 163/00; C09J 11/08

(52) U.S. Cl. CPC C09J 163/00; C09J 11/08

(57) ABSTRACT

The present disclosure is directed to a two component (2K) composition comprising:
(I) a first component comprising:
   a) at least one epoxy silane oligomer according to Formula (AI) wherein:
R^{e} is a C₁-C₆ alkyl group; R^{f} is an epoxide substituted C₁-C₁₂ alkyl group, C₃-C₁₈ cycloalkyl group or C₂-C₁₈ alkoxyalkyl group; R^{g} is H or a C₁-C₆ alkyl group; R^{h} is a C₁-C₆ alkyl group; i is an integer≥1; and j is an integer≥1;
   b) at least one polyepoxide compound having at least three epoxide groups per molecule; and,
   optionally c) at least one compound selected from the group consisting of monoepoxide compounds and diepoxide compounds;
   wherein the compounds of part b) and part c) do not meet Formula (AI);
(II) a second component comprising:
   d) a curative consisting of at least two compounds possessing at least two epoxide reactive groups per molecule, said curative being characterized by comprising: at least one Mannich base; and at least one cycloaliphatic amine,
wherein the two component (2K) composition further comprises:
   e) core shell rubber particles; and,
wherein the two component (2K) composition is further characterized by a molar ratio of epoxide-reactive groups to epoxide groups of from 0.95:1 to 1.5:1.

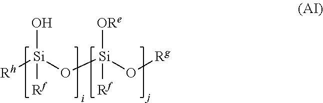

### FIELD OF THE INVENTION

The present disclosure is directed to a two component (2K) composition based on a blend of epoxide compounds. More particularly, the present disclosure is directed to a two component (2K) composition in which the first component comprises a multifunctional epoxide compound and a silane oligomer containing epoxide groups, and the second component comprises a curative possessing epoxide-reactive groups.

### BACKGROUND OF THE INVENTION

Epoxy resins have found a broad range of application, predominantly on the basis that a particular selection of resin, modifier and cross-linking agent (or curative) can allow the properties of the cured epoxy resin to be tailored to achieve specific performance characteristics.

That versatility being acknowledged, properly cured epoxy resins also possess a plurality of other attributes including inter alia: excellent chemical resistance, particularly to alkaline environments; high tensile and compressive strengths; high fatigue strength; low shrinkage upon cure; and electrical insulation properties and retention thereof upon aging or environmental exposure. However, cured epoxy resin systems can also be adversely characterized by diminished fracture resistance and impact strength, low thermal stability, low pigment retention capacity, poor flexibility and poor hydrophobicity.

The present disclosure is directed to “two-component (2K) compositions” which should be understood to be compositions in which a binder component (I)—herein based on epoxide compound(s)—and a hardener component (II) are stored in separate vessels because of their reactivity. The two components are mixed only shortly before application and then react with bond formation and thereby formation of a polymeric network.

While two component (2K) compositions based on epoxide compounds are sometimes capable of a quick initial cure, such rapid curing is usually attained by the use of elevated temperatures which may not be appropriate or practical for all substrates which could be contacted with the composition. Furthermore, using high temperatures to promote a fast rate of cure can also precipitate other problems. Firstly, it can prevent adequate leveling in certain coatings, adhesives or sealant applications. Secondly, it may also limit the breathing of the material: upon high temperature curing, any moisture trapped below the surface of the coating, adhesive or sealant composition may evaporate and induce bubbling or buckling in the cured composition or at least nano-scale material failure. Of course, material failure starts at the nano-scale, which enlarges to micro- and then to macro-scale: exposure to abrasive conditions can accelerate this sequence of failure.

Problematically, at room temperature, two component (2K) epoxy compositions often tend to cure slowly over time and may require from 6 to 8 hours of curing prior to handling, with full cure being achieved in one, two or as many as seven days. Such long processing times can be disadvantageous to many industrial applications. And indeed, a slow curing rate can preclude such two (2) component epoxy compositions from being used in room-temperature, assembly-line processing or in other low temperature applications where a high throughput is required.

A number of authors have sought to address the need to develop two component (2K) epoxy compositions which can provide for a rapid build-up of strength but which are curable at room temperature and thus do not need to incur the energetic costs of heating the composition and/or the substrate to which the composition is to be applied. A prevalent approach is to speed up curing times by adding certain low molecular weight additives (cure accelerators) to, conventionally, the hardener component of 2K epoxy compositions.

US 2005/0143496 (Mueller) discloses a two-component epoxide resin composition comprising: as component A, at least one epoxide resin with an epoxy functionality greater than 1; and, as component B, a liquid or pasty hardener containing amines, polyetheramines, polyaminoamides, Mannich bases and/or compounds containing mercapto groups, which composition additionally contains a non-volatile and non-corrosive accelerator. The two-component composition is intended to be used as a structural adhesive for car body assemblies.

WO2004092244A2; (Huntsman Advanced Materials Americas Inc. discloses a composition which has utility as an accelerator for the curing of an epoxy resin composition at low temperature, said accelerator composition comprising: as a first part a 1-imidazoly[methyl-substituted 2-naphthol compound; and, as a second part a phenol which is liquid at room temperature, the weight ratio of said first part to said second part being from 10:90 to 80:20.

WO2019115110A1 (Hilti AG) discloses a hardener component for a multi-component epoxy resin material to be cured at room temperature, said hardener component including a benzoxazine amine adduct as an accelerator and an amine as a hardener. The benzoxazine amine adduct is present in the hardener component in a proportion of from 8.5 wt. % to 75 wt. % thereof.

The necessary inclusion of accelerators in a room temperature curable composition can, however, be deleterious in that they may increase the brittleness of the cured composition and reduce dynamic strength performance. Further, low molecular weight additives—which are not incorporated into the polymer matrix—can promote over-plasticization of the curing composition in some circumstances.

It has also been observed that epoxy resins compositions which are curable at room temperature demonstrate, after curing, a decline in their adhesive strength when subjected to temperatures elevated above room temperature. This limits their utility to low temperature adhesive applications.

### STATEMENT OF THE INVENTION

In accordance with a first aspect of the invention, there is provided a two component (2K) composition comprising:
(I) a first component comprising:
   a) at least one epoxy silane oligomer according to Formula (AI):

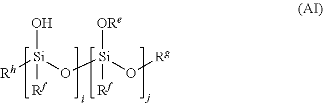

wherein: R^{e} is a C₁-C₆ alkyl group;
   R^{f} is an epoxide substituted C₁-C₁₂ alkyl group, C₃-C₁₈ cycloalkyl group or C₂-C₁₈ alkoxyalkyl group;
   R^{g} is H or a C₁-C₆ alkyl group;
   R^{h} is a C₁-C₆ alkyl group;
   i is an integer≥1; and,
   j is an integer≥1;
b) at least one polyepoxide compound having at least three epoxide groups per molecule; and,
optionally c) at least one compound selected from the group consisting of monoepoxide compounds and diepoxide compounds;
   wherein the compounds of part b) and part c) do not meet Formula (AI);
(II) a second component comprising:
   d) a curative consisting of at least two compounds possessing at least two epoxide reactive groups per molecule, said curative being characterized by comprising: at least one Mannich base; and at least one cycloaliphatic amine,
      wherein the two component (2K) composition further comprises:
e) core-shell rubber particles; and,
   wherein the two component (2K) composition is further characterized by a molar ratio of epoxide-reactive groups to epoxide groups of from 0.95:1 to 1.5:1.

The core-shell rubber particles—denoted as part e)—may be included in the first component, the second component or both components. It is however preferred that at least a portion and preferably at least 60 wt. % or at least 70 wt. % of the core-shell rubber particles are provided in the first component.

In certain embodiments, the two component (2K) composition comprises, based on the weight of the composition:
from 0.1 to 5 wt. %, preferably from 0.5 to 4 wt. % and more preferably from 0.5 to 2 wt. % of a) said at least one epoxy silane oligomer according to Formula (AI);
from 10 to 80 wt. %, from 15 to 75 wt. % and more preferably from 20 to 70 wt. % of b) said at least one polyepoxide compound having at least three epoxide groups per molecule;
from 0 to 20 wt. %, preferably from 0 to 15 wt. % and more preferably from 0 to 10 wt. % of c) said at least one at least one compound selected from the group consisting of monoepoxide compounds and diepoxide compounds;
from 10 to 30 wt. %, preferably from 15 to 30 wt. % of d) said curative; and,
from 5 to 30 wt. %, preferably from 5 to 25 wt. % and more preferably from 10 to 25 wt. % of e) said core shell rubber particles,
   wherein the two component (2K) composition is further characterized by a molar ratio of epoxide-reactive groups to epoxide groups of from 0.95:1 to 1.1:1.

Compositions as defined above have been demonstrated to be curable at room temperature. Moreover, when cured at room temperature, the cured compositions demonstrate favorable adhesive strength at both room temperature and under elevated temperature conditions.

The or each epoxy silane oligomer included in the composition is preferably characterized by a number average molecular weight (Mn) of from 200 to 3000 daltons. Independently of or additional to this characterization, part a) of the composition preferably comprises or consists of at least one compound in accordance with Formula (AII):

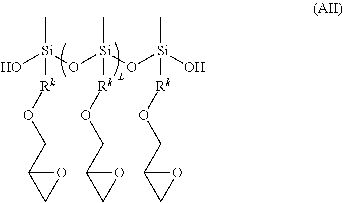

wherein: L is an integer of from 0 to 20, preferably from 1 to 10; and,
R^{k} is C₁-C₆ alkyl, preferably C₁-C₄ alkyl and more preferably C₂-C₃ alkyl.

It is preferred that b) said at least one polyepoxide compound having at least three epoxide groups per molecule is selected from the group consisting of: glycidyl ethers of polyhydric alcohols; glycidyl ethers of polyhydric phenols; glycidyl esters of polycarboxylic acids; polyfunctional glycidylamines; and epoxidized polyethylenically unsaturated hydrocarbons. For example, good results have been obtained where part b) comprises or consists of at least one polyfunctional glycidylamine selected from the group consisting of: N,N,N′,N′-tetraglycidyl-4,4′methylene bisbenzenamine; p-aminophenol triglycidyl ether; m-aminophenol triglycidyl ether; tetraglycidyl bis(aminomethyl)cyclohexane; and N,N,N′,N′-tetraglycidyl-m-xylenediamine.

Part c) of the composition is optional. However, when added, it is preferred that part c) comprises or consists of at least one diepoxide compound having an epoxide equivalent weight of from 100 to 700 g/eq. The least one diepoxide compound may preferably be selected from the group consisting of: glycidyl ethers of diyhydric alcohols; glycidyl ethers of dihydric phenols; glycidyl esters of dicarboxylic acids; and epoxidized polyethylenically unsaturated hydrocarbons.

It is preferred herein that the or each Mannich base of the curative of the composition is a phenalkamine. Independently of or additional to this preference, the or each cycloaliphatic amine of the curative should preferably be selected from the group consisting of: 1,2-, 1,3- and 1,4-diaminocyclohexane; bis(4-aminocyclohexyl)methane; bis(4-amino-3-methylcyclohexyl)methane; bis(4-amino-3-ethylcyclohexyl)methane; bis(4-amino-3,5-dimethylcyclohexyl)methane; bis(4-amino-3-ethyl-5-methylcyclohexyl)methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)-cyclohexane; 1,4-bis(aminomethyl)cyclohexane; 2,5(2,6)-bis(aminomethyl)-bicyclo[2.2.1]heptane (norborane diamine, NBDA); 3(4),8(9)-bis(aminomethyl)tricyclo[5.2.1.02,6]-decane (TCD-diamine); 1,4-diamino-2,2,6-trimethylcyclohexane (TMCDA); N,N-bis(3-aminopropyl)cyclohexylamine; and, 1,8-menthanediamine.

In accordance with a second aspect of the invention, there is provided a cured product obtained from the two component (2K) composition as defined herein above and in the appended claims. The present invention also provides for the use of cured reaction product as a coating, adhesive or sealant.

### Definitions

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps.

As used herein, the term “consisting of” excludes any element, ingredient, member or method step not specified.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Further, in accordance with standard understanding, a weight range represented as being “from 0 to x” specifically includes 0 wt. %: the ingredient defined by said range may be absent from the composition or may be present in the composition in an amount up to x wt. %.

As used herein the term “at least a portion” can refer to any non-zero percentage of a whole amount up to and including 100%. For example, “at least a portion” can refer to at least about 1%, 2%, 3%, 4%, 5%, 6%, 7%, 8%, 9%, 10%, 20%, 30%, 40%, 50%, 60%, 70%, 80%, 90%, 95%, 99%, 99.9% or 100% of a whole amount.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

As used throughout this application, the word “may” is used in a permissive sense—that is meaning to have the potential to—rather than in the mandatory sense.

As used herein, room temperature is 23° C. plus or minus 2° C. As used herein, “ambient conditions” means the temperature and pressure of the surroundings in which the composition is located or in which a coating layer or the substrate of said coating layer is located.

The term “Mannich Base” is used herein in accordance with its standard definition in the art as a ketonic amine obtainable from the condensation of ammonia, diamines or polyamines with active hydrogen components selected from aldehydes, ketones, esters or aromatics (e.g. phenols) and/or heteroaromatics. Phenalkamines—herein acting as curing agents—are Mannich base compounds that are the reaction product of an aldehyde, an amine and a phenolic compound.

As used herein, the term “monomer” refers to a substance that can undergo a polymerization reaction to contribute constitutional units to the chemical structure of a polymer. The term “monofunctionaf”, as used herein, refers to the possession of one polymerizable moiety. The term “polyfunctional”, as used herein, refers to the possession of more than one polymerizable moiety.

As used herein, the term “equivalent (eq.)” relates, as is usual in chemical notation, to the relative number of reactive groups present in the reaction.

As used herein, “(meth)acryl” is a shorthand term referring to “acryl” and/or “methacryl”. Thus, the term “(meth)acrylamide” refers collectively to acrylamide and methacrylamide.

As used herein, “C₁-Cₙ alkyl” group refers to a monovalent group that contains 1 to n carbons atoms, that is a radical of an alkane and includes straight-chain and branched organic groups. As such, a “C₁-C₁₈ alky?” group refers to a monovalent group that contains from 1 to 18 carbons atoms, that is a radical of an alkane and includes straight-chain and branched organic groups. In general, a preference for alkyl groups containing from 1-12 carbon atoms (C₁-C₁₂ alkyl)—for example alkyl groups containing from 1 to 8 carbon atoms (C₁-C₈ alkyl)—should be noted. Examples of alkyl groups include but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more halogen. Where applicable for a given moiety (R), a tolerance for one or more non-halogen substituents within an alkyl group will be noted in the specification.

The term “C₁-C₁₈ hydroxyalkyl” as used herein refers to a HO-(alkyl) group having from 1 to 18 carbon atoms, where the point of attachment of the substituent is through the oxygen-atom and the alkyl group is as defined above.

An “alkoxy group” refers to a monovalent group represented by —OA where A is an alkyl group: non-limiting examples thereof are a methoxy group, an ethoxy group and an iso-propyloxy group. The term “C₂-C₁₈ alkoxyalky” as used herein refers to an alkyl group having an alkoxy substituent as defined above and wherein the moiety (alkyl-O-alkyl) comprises in total from 2 to 18 carbon atoms: such groups include methoxymethyl (—CH₂OCH₃), 2-methoxyethyl (—CH₂CH₂OCH₃) and 2-ethoxyethyl. Analogously, the term “C₇-C₁₈ alkoxyaryl” as used herein refers to an aryl group having an alkoxy substituent as defined above and wherein the moiety (aryl-O-alkyl) has in total from 7 to 18 carbon atoms.

The term “C₂-C₄ alkylene” as used herein, is defined as saturated, divalent hydrocarbon radical having from 2 to 4 carbon atoms.

The term “C₃-C₁₈ cycloalkyl” is understood to mean a saturated, mono- or polycyclic hydrocarbon group having from 3 to 18 carbon atoms. In the present invention, such cycloalkyl groups may be unsubstituted or may be substituted with one or more halogen. Where applicable for a given moiety (R), a tolerance for one or more non-halogen substituents within a cycloalkyl group will be noted in the specification. Examples of cycloalkyl groups include: cyclopropyl; cyclobutyl; cyclopentyl; cyclohexyl; cycloheptyl; cyclooctyl; adamantane; and norbornane.

As used herein, an “C₆-C₁₈ aryl” group used alone or as part of a larger moiety—as in “aralkyl group”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present invention, such aryl groups may be unsubstituted or may be substituted with one or more halogen. Where applicable for a given moiety (R), a tolerance for one or more non-halogen substituents within an aryl group will be noted in the specification. Exemplary aryl groups include: phenyl; (C1-C4)alkylphenyl, such as tolyl and ethylphenyl; indenyl; naphthalenyl, tetrahydronaphthyl, tetrahydroindenyl; tetrahydroanthracenyl; and anthracenyl. And a preference for phenyl groups may be noted.

As used herein, “C₂-C₂₀ alkenyl” refers to hydrocarbyl groups having from 2 to 20 carbon atoms and at least one unit of ethylenic unsaturation. The alkenyl group can be straight chained, branched or cyclic and may optionally be substituted with one or more halogen. Where applicable for a given moiety (R), a tolerance for one or more non-halogen substituents within an alkenyl group will be noted in the specification. The term “alkenyl” also encompasses radicals having “cis” and “trans” configurations, or alternatively, “E” and “Z” configurations, as appreciated by those of ordinary skill in the art. In general, however, a preference for unsubstituted alkenyl groups containing from 2 to 10 (C₂₋₁₀) or 2 to 8 (C₂₋₈) carbon atoms should be noted. Examples of said C₂-C₁₂ alkenyl groups include, but are not limited to: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; —C(CH₃)=CHCH₃; —C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)=CHCH₂CH₃; —CH(CH₃)CH═CHCH; —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “alkylaryl” refers to alkyl-substituted aryl groups, both groups being defined as above. Further, as used herein “aralkyl” means an alkyl group substituted with an aryl radical as defined above.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl”, “heterocycloalkyl” and “heteroaryl” moieties are alkyl, cycloalkyl and aryl groups as defined hereinabove, respectively, containing N, O, Si or S as part of their structure.

The term “equivalent weight” as used herein refers to the molecular weight divided by the number of a function concerned. As such, “epoxy equivalent weight” (EEW) means the weight of resin, in grams, that contains one equivalent of epoxy.

As used herein, the term “epoxide” denotes a compound characterized by the presence of at least one cyclic ether group, namely one wherein an ether oxygen atom is attached to two adjacent carbon atoms thereby forming a cyclic structure. The term is intended to encompass monoepoxide compounds, diepoxide compounds, higher polyepoxide compounds having more than two epoxide groups and epoxide terminated prepolymers. The term “monoepoxide compound” is meant to denote epoxide compounds having one epoxide group. The term “polyepoxide compound” is meant to denote epoxide compounds having at least two epoxide groups. The term “diepoxide compound” is meant to denote epoxide compounds having two epoxide groups.

The epoxide may be unsubstituted but may also be inertly substituted. Exemplary inert substituents include chlorine, bromine, fluorine and phenyl.

The molecular weights referred to in this specification can be measured with gel permeation chromatography (GPC) using polystyrene calibration standards, such as is done according to ASTM 3536.

The Shore A hardness of a given material mentioned herein is determined using a durometer in accordance with ISO 868 entitled “Plastics and Ebonite—Determination of Indentation Hardness by Means of a Durometer (Shore Hardness)”, the contents of which standard are incorporated herein by reference in their entirety. Throughout the present description, all standard Shore A hardness measurements were performed on injection molded plates at 10 seconds using Type A durometer.

Viscosities of the compositions described herein are, unless otherwise stipulated, measured using the Anton Paar Viscometer, Model MCR 301 at standard conditions of 25° C. and 50% Relative Humidity (RH). The viscometer is calibrated one time a year and checked by services. The calibration is done using standard liquids of known viscosity from 1 to 50,000 cps (parallel plate PP20 and at shear rate 1 s⁻¹ at 23° C.). Measurements of the compositions according to the present invention are done using the parallel plate PP20 at different shear rates from 1.5 to 100 s⁻¹.

### DETAILED DESCRIPTION OF THE INVENTION

### a) Epoxy Silane Oligomer

The composition of the present invention comprises a) at least one epoxy silane oligomer according to Formula (AI).

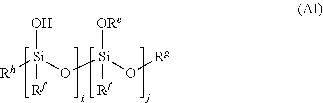

wherein: R^{e} is a C₁-C₆ alkyl group;
R^{f} is an epoxide substituted C₁-C₁₂ alkyl group, C₃-C₁₈ cycloalkyl group or C₂-C₁₈ alkoxyalkyl group;
R^{g} is H or a C₁-C₆ alkyl group;
R^{h} is a C₁-C₆ alkyl group;
i is an integer≥1; and,
j is an integer≥1.

The composition should typically comprise from 0.1 to 5 wt. %, based on the weight of the composition, of a) said at least one epoxy silane oligomer. For example, the composition may comprise from 0.5 to 4 wt. % or from 0.5 to 2 wt. % of said at least one epoxy silane oligomer, based on the weight of the composition.

In certain embodiments of the oligomers of Formula (A1): R^{e} is a C₁-C₂ alkyl group; R^{f} is an epoxide substituted C₁-C₆ alkyl group, C₃-C₁₂ cycloalkyl group or C₂-C₁₂ alkoxyalkyl group; R^{g} is H or a C₁-C₂ alkyl group; R^{h} is a C₁-C₂ alkyl group; i is an integer of from 1 to 20, for example from 1 to 10; and, j is an integer of from 1 to 20, for example from 1 to 10. A preference may be mentioned for R^{f} being an epoxide substituted C₂-C₁₂ alkoxyalkyl group.

For completeness, part a) may comprise a singular compound according to Formula (AI) or may comprise a mixture of compounds according to Formula (AI) which may or may not have different substituents and/or different parameters “i” and “j”.

Independently of, or additional to the above preferred definitions of the substituents, it is preferred that the or each epoxy silane oligomer present in the composition is characterized by a number average molecular weight (Mn) of from 200 to 3000 daltons, for example from 200 to 2000 daltons or from 300 to 1500 daltons.

In an exemplary embodiment, part a) of the composition comprises or consists of at least one compound in accordance with Formula (AII):

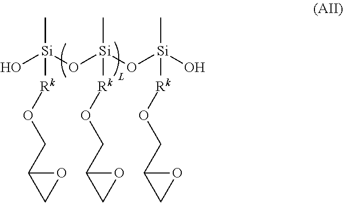

wherein: L is an integer of from 0 to 20; and,
R^{k} is C₁-C₆ alkyl.

It particularly preferred that: L is an integer of from 1 to 10, for example from 1 to 5; and, R^{k} is C₁-C₄ alkyl, for example C₂-C₃ alkyl. For completeness, part a) may in this exemplary embodiment comprise or consist of a singular compound according to Formula (AII) or may comprise a mixture of compounds according to Formula (AII) which may or may not have different values of parameter L and/or different substituents R^{k}.

Oligomers in accordance with Formula (AI) or (AII) may be produced by reacting a glycidoxy silane and/or a cycloaliphatic epoxy silane having either 2 or 3 alkoxy (OR) groups, and optionally, a copolymerizable silane other than said glycidoxy silane and cycloaliphatic epoxy silane in the presence of catalyst: this reaction is performed in the presence of water which is, typically continuously fed into the reaction mixture.

Exemplary reactant glycidoxy silane monomers include but are not limited to: γ-glycidoxypropyl trimethoxysilane; γ-glycidoxypropyl triethoxysilane; γ-glycidoxypropyl methyldimethoxysilane; and, γ-glycidoxypropyl methyldiethoxysilane. Exemplary reactant cycloaliphatic epoxy silane monomers include but are not limited to: β-(3,4-epoxycyclohexyl)-ethyl trimethoxysilane; β-(3,4-epoxycyclohexyl)-ethyl methyl dimethoxysilane; β-(3,4-epoxycyclohexyl)-ethyl methyl diethoxysilane; and β-(3,4-epoxycyclohexyl)-ethyl triethoxysilane. Any copolymerizable monomer present in the reaction mixture—in addition to the glycidoxy silane and/or a cycloaliphatic epoxy silane monomers—should not be reactive towards the epoxide groups under polymerization conditions: exemplary co-monomers which may improve the stability of epoxy silane oligomers are disclosed in inter alia: U.S. Pat. Nos. 3,337,496; 3,341,469; and 5,073,195.

Exemplary catalysts for the synthesis process include: ion exchange resins, such as Amberlite® IRA 400 available from Rohm & Haas or Lewatit® M-500 available from Bayer; alkylammonium salts, such as hexadecyltrimethylammonium chloride, tetra-n-butylammonium chloride, or benzyl trimethyl ammonium halide; and quaternary ammonium organofunctional silanes.

The above synthetic process aside, the epoxy silane oligomer(s) may be obtained from commercial sources. Mention in this regard may be made of CoatOSil MP200 (CAS Number 68611-45-0) available from Momentive Performance Materials Inc.

### b) Polyepoxide Compounds

The composition of the present invention comprises b) at least one polyepoxide compound having at least three epoxide groups per molecule: for surety, this polyepoxide compound (b)) is distinct from the compound or compounds included in part a) of the composition. Typically, the composition should comprise, based on the weight of the composition, from 10 to 80 wt. % of b) said at least one polyepoxide compound. For example, the composition may comprise from 15 to 75 wt. % or from 20 to 70 wt. % of b) said at least polyepoxide compound, based on the weight of the composition.

The polyepoxide compounds may be pure compounds but equally may be mixtures epoxide functional compounds, including mixtures of compounds having different numbers of epoxide groups per molecule. A polyepoxide compound may be saturated or unsaturated, aliphatic, cycloaliphatic, aromatic or heterocyclic and may be substituted. Further, the polyepoxide compound may also be monomeric or polymeric.

Without intention to limit the present invention, suitable polyepoxide compounds may be liquid, solid or in solution in solvent. Further, such polyepoxide compounds should have an epoxide equivalent weight of from 100 to 700 g/eq, for example from 120 to 320 g/eq. And generally, polyepoxide compounds having epoxide equivalent weights of less than 500 g/eq. or even less than 400 g/eq. are preferred: this is predominantly from a costs standpoint, as in their production, lower molecular weight epoxy resins require more limited processing in purification.

As examples of types or groups of polyepoxide compounds which may be included in the composition, mention may be made of: glycidyl ethers of polyhydric alcohols; glycidyl ethers of polyhydric phenols; glycidyl esters of polycarboxylic acids; polyfunctional glycidylamines; and epoxidized polyethylenically unsaturated hydrocarbons.

Exemplary polyglycidyl ethers, which may be employed alone or in combination, include but are not limited to: glycerol polyglycidyl ether; trimethylolmethane triglycidyl ether; trimethylolethane triglycidyl ether; trimethylolpropane triglycidyl ether; pentaerythritol polyglycidyl ether; diglycerol polyglycidyl ether; polyglycerol polyglycidyl ether; sorbitol polyglycidyl ether; triphenylolmethane triglycidyl ether; trisphenol triglycidyl ether; trihydroxybiphenyl triglycidyl ether; tetraphenylol ethane triglycidyl ether; tetraglycidyl ether of tetraphenylol ethane; 1,2,6-hexanetriol triglycidyl ether; glycerol triglycidyl ether; diglycerol triglycidyl ether; glycerol ethoxylate triglycidyl ether; castor oil triglycidyl ether; fluoroglycinol triglycidyl ether; and, propoxylated glycerine triglycidyl ether. Further, the glycidyl ethers of phenol-formaldehyde novolac resins, cresol-formaldehyde novolac resins, brominated phenol-formaldehyde novolac resins, brominated cresol-formaldehyde novolac resins, 3,3′,5,5′-tetramethyl-(1,1′,-biphenyl)-2,4,4′-triol and pyrogallol may be utilized in the present disclosure. And mention may also be made of 2,2′-[(1-methylethylidene)bis[[6-(2-oxiranylmethoxy)-3,1˜phenylene]methylene]]bis-oxirane (CAS No. 1799411-80-5) as having utility herein.

Glycidyl esters of polycarboxylic acids having utility in the present invention are derived from polycarboxylic acids which contain three or more carboxylic acid groups and no other groups reactive with epoxide groups. The polycarboxylic acids can be aliphatic, cycloaliphatic, aromatic or heterocyclic. The preferred polycarboxylic acids are those which contain not more than 18 carbon atoms per carboxylic acid group of which suitable examples include but are not limited to: aconitic acid; propane-1,2,3-tricarboxylic acid (β-carboxyglutaric acid); trimer acids of unsaturated fatty acids, such as trimer acids of linseed fatty acids; trimellitic acid; trimesic acid; and polymers and co-polymers of (meth)acrylic acid.

Exemplary polyglycidyl amines, which may be used alone or in the combination, include but are not limited to: N,N,N′,N′-tetraglycidyl-4,4′methylene bisbenzenamine; p-aminophenol triglycidyl ether; m-aminophenol triglycidyl ether; tetraglycidyl bis(aminomethyl)cyclohexane; and N,N,N′,N′-tetraglycidyl-m-xylenediamine.

And examples of highly preferred commercial polyepoxide compounds include: 2,2′-[(1-methylethylidene)bis[[6-(2-oxiranylmethoxy)-3,1-phenylene]methylene]]bis-oxirane, available as SHOFREE BATG from Showa Denko; castor oil triglycidyl ether, such as ERISYS™ GE-35H; polyglycerol-3-polyglycidyl ether, such as ERISYS™ GE-38; sorbitol glycidyl ether, such as ERISYS™ GE-60; Epikote 1032H60 (manufactured by Japan Epoxy Resins Co., Ltd.); Epikote 1031S (manufactured by Japan Epoxy Resins Co., Ltd.); TECHMORE VG3101 (manufactured by Mitsui Chemicals, Inc.); polyfunctional glycidylamines, such as Kane Ace 414 (available from Kaneka Corporation), ELM-100 (manufactured by Sumitomo Chemical Co., Ltd.), MY721 and MY0510 (manufactured by Ciba Specialty Chemicals Inc.), Araldite® MY0600-CH (available from Hunstman) and Tetrad® X and Tetrad® C available from Mitsubishi Gas Chemicals Co.; and, dicyclopentadiene type epoxy resins, such as ZX-1257 (manufactured by Tohto Kasei Co., Ltd.) and HP-7200 (manufactured by Dainippon Ink and Chemicals Incorporated).

### c) Further Epoxide Compounds

The first component of the composition of the present disclosure may comprise from 0 to 20 wt. %, based on the weight of said component, of c) at least one compound selected from the group consisting of monoepoxide compounds and diepoxide compounds not meeting the definitions of part a) above. For example, the first component of the composition may contain from 0 to 15 wt. % or from 0 to 10 wt. % of c) said at least one epoxide compound, based on the weight of said component.

Part c) of the composition may thereby comprise: one or more monoepoxide compounds; one or more diepoxide compounds; or a combination thereof. Thus, part c) may be a mixture of epoxide functional compounds, including mixtures of compounds having different numbers of epoxide groups per molecule. The monoepoxide or diepoxide compound may be saturated or unsaturated, aliphatic, cycloaliphatic, aromatic or heterocyclic and may be substituted. Further, the monoepoxide or diepoxide compound may also be monomeric or polymeric.

Without intention to limit the present invention, illustrative monoepoxide compounds include: alkylene oxides; epoxy-substituted cycloaliphatic hydrocarbons, such as cyclohexene oxide, vinylcyclohexene monoxide, (+)-cis-limonene oxide, (+)-cis,trans-limonene oxide, (−)-cis,trans-limonene oxide, cyclooctene oxide, cyclododecene oxide and α-pinene oxide; epoxy-substituted aromatic hydrocarbons; monoepoxy substituted alkyl ethers of monohydric alcohols or phenols, such as the glycidyl ethers of aliphatic, cycloaliphatic and aromatic alcohols; monoepoxy-substituted alkyl esters of monocarboxylic acids, such as glycidyl esters of aliphatic, cycloaliphatic and aromatic monocarboxylic acids; monoepoxy-substituted alkyl esters of polycarboxylic acids wherein the other carboxy group(s) are esterified with alkanols; alkyl and alkenyl esters of epoxy-substituted monocarboxylic acids; epoxyalkyl ethers of polyhydric alcohols wherein the other OH group(s) are esterified or etherified with carboxylic acids or alcohols; and, monoesters of polyhydric alcohols and epoxy monocarboxylic acids, wherein the other OH group(s) are esterified or etherified with carboxylic acids or alcohols.

By way of example, the following glycidyl ethers might be mentioned as being particularly suitable monoepoxide compounds for use herein: methyl glycidyl ether; ethyl glycidyl ether; propyl glycidyl ether; butyl glycidyl ether; pentyl glycidyl ether; hexyl glycidyl ether; cyclohexyl glycidyl ether; octyl glycidyl ether; 2-ethylhexyl glycidyl ether; allyl glycidyl ether; benzyl glycidyl ether; phenyl glycidyl ether; 4-tert-butylphenyl glycidyl ether; 1-naphthyl glycidyl ether; 2-naphthyl glycidyl ether; 2-chlorophenyl glycidyl ether; 4-chlorophenyl glycidyl ether; 4-bromophenyl glycidyl ether; 2,4,6-trichlorophenyl glycidyl ether; 2,4,6-tribromophenyl glycidyl ether; pentafluorophenyl glycidyl ether; o-cresyl glycidyl ether; m-cresyl glycidyl ether; and, p-cresyl glycidyl ether.

In an important embodiment, the monoepoxide compound conforms to Formula (CI) herein below:

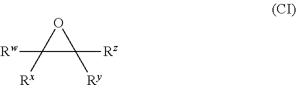

wherein: R^{w}, R^{x}, R^{y} and R^{z} may be the same or different and are independently selected from hydrogen, a halogen atom, a C₁-C₈alkyl group, a C₃ to C₁₀ cycloalkyl group, a C₂-C₁₂ alkenyl, a C₆-C₁₈ aryl group or a C₇-C₁₈ aralkyl group, with the proviso that at least one of R^{y} and R^{z} is not hydrogen.

It is preferred that R^{w}, R^{x} and R^{y} are hydrogen and R^{z} is either a phenyl group or a C₁-C₈ alkyl group and, more preferably, a C₁-C₄ alkyl group. Having regard to this embodiment, exemplary monoepoxides include: ethylene oxide; 1,2-propylene oxide (propylene oxide); 1,2-butylene oxide; cis-2,3-epoxybutane; trans-2,3-epoxybutane; 1,2-epoxypentane; 1,2-epoxyhexane; 1,2-heptylene oxide; decene oxide; butadiene oxide; isoprene oxide; and styrene oxide.

In the present invention, reference is made to using at least one monoepoxide compound selected from the group consisting of: ethylene oxide; propylene oxide; cyclohexene oxide; (+)-cis-limonene oxide; (+)-cis,trans-limonene oxide; (−)-cis,trans-limonene oxide; cyclooctene oxide; and cyclododecene oxide.

Again, without intention to limit part c) of the present invention, suitable diepoxide compounds may be liquid, solid or in solution in solvent. Further, such diepoxide compounds should have an epoxide equivalent weight of from 100 to 700 g/eq, for example from 120 to 320 g/eq. And generally, diepoxide compounds having epoxide equivalent weights of less than 500 g/eq. or even less than 400 g/eq. are preferred: this is predominantly from a costs standpoint, as in their production, lower molecular weight epoxy resins require more limited processing in purification.

As examples of types or groups of diepoxide compounds which may be included in the composition, mention may be made of: glycidyl ethers of dihydric alcohols; glycidyl ethers of dihydric phenols; glycidyl esters of dicarboxylic acids; and epoxidized diethylenically unsaturated hydrocarbons.

Suitable diglycidyl ether compounds may be aromatic, aliphatic or cycloaliphatic in nature and, as such, can be derivable from dihydric phenols and dihydric alcohols. And useful classes of such diglycidyl ethers are: diglycidyl ethers of aliphatic and cycloaliphatic diols, such as 1,2-ethanediol, 1,4-butanediol, 1,6-hexanediol, 1,8-octanediol, 1,12-dodecanediol, cyclopentane diol, cyclohexane diol and isosorbide; bisphenol A based diglycidylethers; bisphenol F diglycidyl ethers; polyalkyleneglycol based diglycidyl ethers, in particular polypropyleneglycol diglycidyl ethers; and polycarbonatediol based glycidyl ethers.

Glycidyl esters of dicarboxylic acids having utility in the present invention are derived from carboxylic acids which contain two carboxylic acid groups and no other groups reactive with epoxide groups. The dicarboxylic acids can be aliphatic, cycloaliphatic, aromatic or heterocyclic. The preferred dicarboxylic acids are those which contain no more than 18 carbon atoms per carboxylic acid group, of which suitable examples include but are not limited to: oxalic acid; sebacic acid; adipic acid; succinic acid; pimelic acid; suberic acid; glutaric acid; dimer acids of unsaturated fatty acids, such as dimer acids of linseed fatty acids; phthalic acid; isophthalic acid; terephthalic acid; phenylene-diacetic acid; chlorendic acid; hexahydrophthalic acid, in particular hexahydroorthophthalic acid (1,2-cyclohexanedicarboxylic acid); diphenic acid; naphthalic acid; polyacid terminated esters of di-basic acids and aliphatic polyols; and, polymers and co-polymers of (meth)acrylic acid.

Other suitable diepoxides which might also be mentioned include: diepoxides of double unsaturated fatty acid C₁-C₁₈ alkyl esters; butadiene diepoxide; polybutadiene diglycidyl ether; vinylcyclohexene diepoxide; and limonene diepoxide.

And examples of highly preferred diepoxide compounds include: bisphenol-A epoxy resins, such as DER™ 331, DER™ 332, DER™ 383, JER™ 828 and Epotec YD 128; bisphenol-F epoxy resins, such as DER™ 354; bisphenol-A/F epoxy resin blends, such as DER™ 353; polypropylene glycol diglycidyl ethers, such as DER™ 732; solid bisphenol-A epoxy resins, such as DER™ 661 and DER™ 664 UE; solutions of bisphenol-A solid epoxy resins, such as DER™ 671-X75; brominated epoxy resins such as DER™ 542; and, bis(2,3-epoxypropyl)cyclohexane-1,2-dicarboxylate, available as Lapox Arch-11.

In addition to the epoxy silane oligomers described above in part a), the composition may in certain embodiments comprise monomeric epoxy silanes and, more particularly, glycidoxy alkyl alkoxy silanes having the formula:

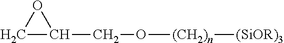

wherein: each R is independently selected from methyl or ethyl; and,
n is from 1-10.

Exemplary monomeric epoxy silanes include but are not limited to: γ-glycidoxy propyl trimethoxy silane, γ-glycidoxy ethyl trimethoxy silane, γ-glycidoxy methyl trimethoxy silane, γ-glycidoxy methyl triethoxy silane, γ-glycidoxy ethyl triethoxy silane, γ-glycidoxy propyl triethoxy silane; and 8-glycidooxyoctyl trimethoxysilane. When present, the monomeric epoxide functional silanes should constitute less than less than 10 wt. %, preferably less than 5 wt. % or less than 2 wt. %, based on the total weight of the epoxide functional compounds in the first component ((a), b) and c)).

Whilst it does not represent a preferred embodiment, the present invention does not preclude the first component of the curable compositions further comprising one or more cyclic monomers selected from the group consisting of: oxetanes; cyclic carbonates; cyclic anhydrides; and lactones. The disclosures of the following citations may be instructive in disclosing suitable cyclic carbonate functional compounds: U.S. Pat. Nos. 3,535,342; 4,835,289; 4,892,954; UK Patent No. GB-A-1,485,925; and EP-A-0 119 840. However, such cyclic co-monomers should constitute less than 10 wt. %, preferably less than 5 wt. % or less than 2 wt. %, based on the total weight of the epoxide functional compounds in the first component (a), b) and c)).

### d) Curative

The curative d), disposed in the second component of the composition, necessarily consists of at least two compounds which each possess at least two epoxide reactive groups per molecule, wherein said curative is characterized by comprising: at least one Mannich base; and at least one cycloaliphatic amine. Moreover, in a preferred embodiment, said at least one Mannich base is a phenalkamine and in particular a phenalkamine obtained from the condensation of cardanol (CAS Number: 37330-39-5), an aldehyde and an amine. The reactant amine in the condensation reaction is desirably ethylenediamine or diethyltriamine.

Mannich bases and phenalkamines are known in the art and suitable examples include the commercially available phenalkamines Cardolite® NC-541, NC-557, NC-558, NC-566, Lite 2001 and Lite 2002 (available from Cardolite), Aradur® 3440, 3441, 3442 and 3460 (available from Huntsman) and Beckopox® EH 614, EH 621, EH 624, EH 628 and EH 629 (available from Cytec).

The term “cycloaliphatic amine” refers to a molecule with an amine group which is connected to an aliphatic carbon atom of a cycloaliphatic moiety. The term “cycloaliphatic” denotes a saturated or unsaturated but non-aromatic carbocyclic radical comprising one or several fused rings, which rings may be optionally fused. The cycloaliphatic group may be unsubstituted or may optionally be substituted with one or more halogen. The term “cycloaliphatic” also includes “heterocycloaliphatid” groups, that is non-aromatic monocyclic or polycyclic rings in which one or more carbon atoms of the ring(s) have been replaced with a heteroatom. Herein the cycloaliphatic group is preferably a C₃-C₁₈ cycloalkyl group of which specific mention may be made of cycloheptyl, cyclohexyl and cyclopentyl groups.

It is preferred herein that the cycloaliphatic amine is a primary amine and contains at least one primary amine group (—NH₂). The cycloaliphatic radicals are preferably present at either the alpha-position directly attached to the amine group or at the beta position adjacent to said alpha-position.

Exemplary cycloaliphatic amines having utility in the present invention include but are not limited to: 1,2-, 1,3- and 1,4-diaminocyclohexane; bis(4-aminocyclohexyl)methane; bis(4-amino-3-methylcyclohexyl)methane; bis(4-amino-3-ethylcyclohexyl)methane; bis(4-amino-3,5-dimethylcyclohexyl)methane; bis(4-amino-3-ethyl-5-methylcyclohexyl)methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)-cyclohexane; 1,4-bis(aminomethyl)cyclohexane; 2,5(2,6)-bis(aminomethyl)-bicyclo[2.2.1]heptane (norborane diamine, NBDA); 3(4),8(9)-bis(aminomethyl)tricyclo[5.2.1.02,6]-decane (TCD-diamine); 1,4-diamino-2,2,6-trimethylcyclohexane (TMCDA); N,N-bis(3-aminopropyl)cyclohexylamine; 1,8-menthanediamine; N-cyclohexyl-1,2-ethanediamine; N-cyclohexyl-1,3-propanediamine; 3-cyclohexylamino-1-pentylamine; 4-aminomethyl-piperidine; N-(2-aminoethyl)piperazine; and, mixtures thereof.

Commercial examples of cycloaliphatic amines having utility in the present invention include: Ancamine 2264, Ancamine 2280 and Ancamine 2286 available from Air Product and Chemical Inc.; Baxxodur EC331, available from BASF; Versamine C31, available from Cognis; and Epicure 3300 available from Momentive Specialty Chemicals. It is preferred that the curative d) consists of or consists essentially of said at least one Mannich base(s) and said at least one cycloaliphatic amine. However, it is not precluded that the curative may comprise—in an amount up to 10 mol. %, based on the total moles of said curative—further compounds possessing at least two epoxide reactive groups per molecule. Such supplementary compounds may, in particular, include either one or both of: i) at least one polyamine which possesses at least two amine hydrogens reactive toward epoxide groups but which is not a cycloaliphatic amine; and ii) at least one mercapto compound having at least two mercapto groups reactive toward epoxide groups.

The at least one polyamine having at least two amine hydrogens reactive toward epoxide groups should, in particular, contain primary and/or secondary amine groups and have an equivalent weight per primary or secondary amine group of not more than 150 g/eq., more preferably not more than 125 g/eq.

Suitable polyamines, which may be used alone or in combination, include but are not limited to the following:
i) Aliphatic or arylaliphatic primary diamines of which the following examples may be mentioned: 2,2-dimethyl-1,3-propanediamine; 1,3-pentanediamine (DAMP); 1,5-pentanediamine; 1,5-diamino-2-methylpentane (MPMD); 2-butyl-2-ethyl-1,5-pentanediamine (C11-neodiamine); 1,6-hexanediamine (hexamethylenediamine, HMDA); 2,5-dimethyl-1,6-hexanediamine; 2,2,4- and/or 2,4,4-trimethylhexamethylenediamine; 1,7-heptanediamine; 1,8-octanediamine; 1,9-nonanediamine; 1,10-decanediamine; 1,11-undecanediamine; 1,12-dodecanediamine; 3,9-bis(3-aminopropyl)-2,4,8,10-tetraoxaspiro[5.5]undecane; and, 1,3-bis(aminomethyl)benzene (MXDA).
ii) Tertiary amine group-containing polyamines with two or three primary aliphatic amine groups of which the following specific examples may be mentioned: N,N′-bis(aminopropyl)-piperazine; N,N-bis(3-aminopropyl)methylamine; N,N-bis(3-aminopropyl)ethylamine; N,N-bis(3-aminopropyl)propylamine; N,N-bis(3-aminopropyl)-2-ethyl-hexylamine; tris(2-aminoethyl)amine; tris(2-aminopropyl)amine; tris(3-aminopropyl)amine; and, the products from the double cyanoethylation and subsequent reduction of fatty amines derived from natural fatty acids, such as N,N-bis(3-aminopropyl)dodecylamine and N,N-bis(3-aminopropyl)tallow alkylamine, commercially available as Triameen® Y12D and Triameen® YT (from Akzo Nobel).
iii) Ether group-containing aliphatic primary polyamines of which the following specific examples may be mentioned: bis(2-aminoethyl)ether; 3,6-dioxaoctane-1,8-diamine; 4,7-dioxadecane-1,10-diamine; 4,7-dioxadecane-2,9-diamine; 4,9-dioxadodecane-1,12-diamine; 5,8-dioxadodecane-3,10-diamine; 4,7,10-trioxatridecane-1,13-diamine and higher oligomers of these diamines; bis(3-aminopropyl)polytetrahydrofuranes and other polytetrahydrofuran diamines; cycloaliphatic ether group-containing diamines obtained from the propoxylation and subsequent amination of 1,4-dimethylolcyclohexane, such as that material commercially available as Jeffamine® RFD-270 (from Huntsman); polyoxyalkylenedi- or -triamines obtainable as products from the amination of polyoxyalkylenedi- and -triols and which are commercially available under the name of Jeffamine® (from Huntsman), under the name of polyetheramine (from BASF) or under the name of PC Amines® (from Nitroil). A particular preference may be noted for the use of Jeffamine® D-230, Jeffamine® D-400, Jeffamine® D-600, Jeffamine® D-2000, Jeffamine® D-4000, Jeffamine® T-403, Jeffamine® T-3000, Jeffamine® T-5000, Jeffamine® EDR-104, Jeffamine® EDR-148 and Jeffamine® EDR-176, as well as corresponding amines from BASF or Nitroil.
iv) Primary diamines with secondary amine groups of which the following examples may be mentioned: 3-(2-aminoethyl)aminopropylamine, bis(hexamethylene)triamine (BHMT); diethylenetriamine (DETA); triethylenetetramine (TETA); tetraethylenepentamine (TEPA); pentaethylenehexamine (PEHA); higher homologs of linear polyethyleneamines, such as polyethylene polyamines with 5 to 7 ethyleneamine units (so-called “higher ethylenepolyamine,” HEPA); products from the multiple cyanoethylation or cyanobutylation and subsequent hydrogenation of primary di- and polyamines with at least two primary amine groups, such as dipropylenetriamine (DPTA), N-(2-aminoethyl)-1,3-propanediamine (N3-amine), N,N′-bis(3-aminopropyl)ethylenediamine (N4-amine), N,N′-bis(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-1,5-pentanediamine or N,N′-bis(3-amino-1-ethylpropyl)-2-methyl-1,5-pentanediamine.
v) Polyamines with one primary and at least one secondary amino group of which the following examples may be mentioned: N-butyl-1,2-ethanediamine; N-hexyl-1,2-ethanediamine; N-(2-ethylhexyl)-1,2-ethanediamine; N-methyl-1,3-propanediamine; N-butyl-1,3-propanediamine; N-(2-ethylhexyl)-1,3-propanediamine; 3-methylamino-1-pentylamine; 3-ethylamino-1-pentylamine; fatty diamines such as N-cocoalkyl-1,3-propanediamine; products from the Michael-type addition reaction of primary aliphatic diamines with acrylonitrile, maleic or fumaric acid diesters, citraconic acid diesters, acrylic and methacrylic acid esters, acrylic and methacrylic acid amides and itaconic acid diesters, reacted in a 1:1 molar ratio; products from the partial reductive alkylation of primary polyamines with aldehydes or ketones, especially N-monoalkylation products of the previously mentioned polyamines with two primary amine groups and in particular of 1,6-hexanediamine, 1,5-diamino-2-methylpentane, 1,3-bis(aminomethyl)cyclohexane, 1,4-bis(aminomethyl)cyclohexane, 1,3-bis(aminomethyl)benzene, BHMT, DETA, TETA, TEPA, DPTA, N3-amine and N4-amine, wherein preferred alkyl groups are benzyl, isobutyl, hexyl and 2-ethylhexyl; and, partially styrenated polyamines such as those commercially available as Gaskamine® 240 (from Mitsubishi Gas Chemical).
vi) Secondary diamines and, in particular, N,N′-dialkylation products of the previously mentioned polyamines with two primary amine groups, especially N,N′-dialkylation products of 1,6-hexanediamine, 1,5-diamino-2-methylpentane, 1,3-bis(aminomethyl)cyclohexane, 1,4-bis(aminomethyl)-cyclohexane, 1,3-bis(aminomethyl)benzene, BHMT, DETA, TETA, TEPA, DPTA, N3-amine or N4-amine, wherein preferred alkyl groups are 2-phenylethyl, benzyl, isobutyl, hexyl and 2-ethylhexyl.
vii) Aromatic polyamines of which mention may be made of: m- and p-phenylenediamine; 4,4′-, 2,4′ and 2,2′-diaminodiphenylmethane; 3,3′-dichloro-4,4′-diaminodiphenylmethane (MOCA); 2,4- and 2,6-tolylenediamine; mixtures of 3,5-dimethylthio-2,4- and -2,6-tolylenediamine (available as Ethacure® 300 from Albermarle); mixtures of 3,5-diethyl-2,4- and -2,6-tolylene diamine (DETDA); 3,3′,5,5′-tetraethyl-4,4′-diaminodiphenylmethane (M-DEA); 3,3′,5,5′-tetraethyl-2,2′-dichloro-4,4′-diaminodiphenylmethane (M-CDEA); 3,3′-diisopropyl-5,5′-dimethyl-4,4′-diaminodiphenylmethane (M-MIPA); 3,3′,5,5′-tetraisopropyl-4,4′-diaminodiphenylmethane (M-DIPA); 4,4′-diamino diphenyl-sulfone (DDS); 4-amino-N-(4-aminophenyl)benzenesulfonamide; 5,5′-methylenedianthranilic acid; dimethyl-(5,5′-methylenedianthranilate); 1,3-propylene-bis(4-aminobenzoate); 1,4-butylene-bis(4-aminobenzoate); polytetramethylene oxide-bis(4-aminobenzoate) (available as Versalink® from Air Products); 1,2-bis(2-aminophenylthio)ethane, 2-methylpropyl-(4-chloro-3,5-diaminobenzoate); and, tert.butyl-(4-chloro-3,5-diaminobenzoate).
viii) Polyamidoamines of which indicative members include the reaction products of monohydric or polyhydric carboxylic acids or the esters or anhydrides thereof, —in particular dimer fatty acids—and an aliphatic, cycloaliphatic or aromatic polyamine, for instance polyalkyleneamines such as DETA or TETA. Commercially available polyamidoamines include: Versamid®100, 125, 140 and 150 (from Cognis); Aradur® 223, 250 and 848 (from Huntsman); Euretek® 3607 and 530 (from Huntsman); and Beckopox® EH 651, EH 654, EH 655, EH 661 and EH 663 (from Cytec).

As noted above, the composition of the present invention may optionally comprise at least one compound which has at least two reactive mercapto- groups per molecule. Suitable mercapto-group containing compounds, which may be used alone or in combination, include but are not limited to the following.
Liquid mercaptan-terminated polysulfide polymers of which commercial examples include: Thiokol® polymers (available from Morton Thiokol), in particular the types LP-3, LP-33, LP-980, LP-23, LP-55, LP-56, LP-12, LP-31, LP-32 and LP-2 thereof; and, Thioplast® polymers (from Akzo Nobel), in particular the types G10, G112, G131, G1, G12, G21, G22, G44 and G 4.
Mercaptan-terminated polyoxyalkylene ethers, obtainable by reacting polyoxyalkylenedi- and -triols either with epichlorohydrin or with an alkylene oxide, followed by sodium hydrogen sulfide.
Mercaptan-terminated compounds in the form of polyoxyalkylene derivatives, known under the trade name of Capcure® (from Cognis), in particular the types WR-8, LOF and 3-800 thereof.
Polyesters of thiocarboxylic acids of which particular examples include: pentaerythritol tetramercapto-acetate (PETMP); trimethylolpropane trimercaptoacetate (TMPMP); glycol dimercaptoacetate; and, the esterification products of polyoxyalkylene diols and triols, ethoxylated trimethylolpropane and polyester diols with thiocarboxylic acids such as thioglycolic acid and 2- or 3-mercaptopropionic acid.
2,4,6-trimercapto-1,3,5-triazine, 2,2′-(ethylenedioxy)-diethanethiol (triethylene glycol dimercaptan) and/or ethanedithiol.

A preference for the use of polyesters of thiocarboxylic acids and, in particular, for the use of at least one of pentaerythritol tetramercapto-acetate (PETMP), trimethylolpropane trimercaptoacetate (TMPMP) and glycol dimercaptoacetate is acknowledged.

When formulating the curable composition, it is preferred that the curative is included in such an amount that the composition in toto is characterized by a molar ratio of epoxide-reactive groups to epoxide groups from 0.95:1 to 1.5:1, for example from 0.95:1 to 1.1:1. Notably, the molar ratio of epoxide-reactive groups to epoxide groups of 1:1 is included within these stated ranges and itself represents a highly preferred molar ratio.

Subject to meeting the above molar ratio terms, the composition may be further characterized by comprise from 10 to 30 wt. %, for example from 15 to 30 wt. % of d) said curative, based on the weight of the composition.

### d) Toughener

The compositions of the present invention contain a toughening rubber in the form of core-shell particles. Whilst such particles might in principle be included in either the first or seconds components, it will be typical for the core-shell particles to added dispersed in the epoxy resins of the first component.

The term “core shell rubber” or CSR is being employed in accordance with its standard meaning in the art as denoting a rubber particle core formed by a polymer comprising an elastomeric or rubbery polymer as a main ingredient and a shell layer formed by a polymer which is graft polymerized onto the core. The shell layer partially or entirely covers the surface of the rubber particle core in the graft polymerization process. By weight, the core should constitute at least 50 wt. % of the core-shell rubber particle.

The polymeric material of the core should have a glass transition temperature (T_{g}) of no greater than 0° C. and preferably a glass transition temperature (T_{g}) of −20° C. or lower, more preferably −40° C. or lower and even more preferably −60° C. or lower. The polymer of the shell is non-elastomeric, thermoplastic or thermoset polymer having a glass transition temperature (T_{g}) of greater than room temperature, preferably greater than 30° C. and more preferably greater than 50° C.

Without intention to limit the invention, the core may be comprised of: a diene homopolymer, for example, a homopolymer of butadiene or isoprene; a diene copolymer, for example a copolymer of butadiene or isoprene with one or more ethylenically unsaturated monomers, such as vinyl aromatic monomers, (meth)acrylonitrile or (meth)acrylates; polymers based on (meth)acrylic acid ester monomers, such as polybutylacrylate; and, polysiloxane elastomers such as polydimethylsiloxane and crosslinked polydimethylsiloxane.

Similarly without intention to limit the present invention, the shell may be comprised of a polymer or copolymer of one or more monomers selected from: (meth)acrylates, such as methyl methacrylate; vinyl aromatic monomers, such as styrene; vinyl cyanides, such as acrylonitrile; unsaturated acids and anhydrides, such as acrylic acid; and, (meth)acrylamides. The polymer or copolymer used in the shell may possess acid groups that are cross-linked ionically through metal carboxylate formation, in particular through forming salts of divalent metal cations. The shell polymer or copolymer may also be covalently cross-linked by monomers having two or more double bonds per molecule.

It is preferred that any included core-shell rubber particles have an average particle size (d50) of from 10 nm to 300 nm, for example from 50 nm to 200 nm: said particle size refers to the diameter or largest dimension of a particle in a distribution of particles and is measured via dynamic light scattering.

The present application does not preclude the presence of two types of core shell rubber (CSR) particles with different particle sizes in the composition to provide a balance of key properties of the resultant cured product, including shear strength, peel strength and resin fracture toughness. In this embodiment, smaller included particles (1^{st} CSR type) may have an average particle size of from 10 to 100 nm and larger included particles (2^{nd} CSR type) may have an average particle size of from 120 nm to 300 nm, for example from 150 to 300 nm. The smaller core shell rubber particles should typically be employed in excess of the larger particles on a weight basis: a weight ratio of smaller CSR particles to larger CSR particles of from 3:1 to 5:1 may be employed for instance.

The core-shell rubber may be selected from commercially available products, examples of which include: Paraloid EXL 2650A, EXL 2655 and EXL2691 A, available from The Dow Chemical Company; the Kane Ace® MX series available from Kaneka Corporation, and in particular MX 120, MX 125, MX 130, MX 136, MX 551, MX553; and, METABLEN SX-006 available from Mitsubishi Rayon.

The core shell rubber particles should be included in the composition in an amount of from 5 to 30 wt. %, for example from 5 to 25 wt. % or from 10 to 25 wt. %, based on the total weight of the composition.

### f) Additives and Adjunct Ingredients

Said compositions obtained in the present invention will typically further comprise adjuvants and additives that can impart improved properties to these compositions. For instance, the adjuvants and additives may impart one or more of: improved elastic properties; improved elastic recovery; longer enabled processing time; faster curing time; and, lower residual tack. Included among such adjuvants and additives—which independently of one another may be included in single components or both components of a two (2K) component composition—are: catalysts; plasticizers; stabilizers including UV stabilizers; antioxidants; tougheners; fillers; reactive diluents; drying agents; adhesion promoters; fungicides; flame retardants; rheological adjuvants; color pigments, such as titanium dioxide, iron oxides, or carbon black; color pastes; dyes; and/or optionally also, to a small extent, non-reactive diluents.

For completeness, it is noted that in general adjunct materials and additives which contain epoxide-reactive groups will be blended into the hardener component of a two (2K) component composition. Materials that contain epoxide groups or which are reactive with the hardener(s) are generally formulated into the epoxide-containing component of a two (2K) component composition. Unreactive materials may be formulated into either or both of the A and B components.

The use of catalysts is not required in the present application and indeed, in preferred embodiments, the composition may be characterized by being substantially free of catalysts. However, in certain circumstances it may be advantageous to add, as a catalyst, one or more substances that promote the reaction between the epoxide groups and the epoxide-reactive groups, for instance the reaction between the amine groups and the epoxide groups.

Without intention to the limit the catalysts used in the present invention, mention may be made of the following suitable catalysts: i) acids or compounds hydrolyzable to acids, in particular a) organic carboxylic acids, such as acetic acid, benzoic acid, salicylic acid, 2-nitrobenzoic acid and lactic acid; b) organic sulfonic acids, such as methanesulfonic acid, p-toluenesulfonic acid and 4-dodecylbenzenesulfonic acid; c) sulfonic acid esters; d) inorganic acids, such as phosphoric acid; e) Lewis acid compounds, such as BF₃ amine complexes, SbF₆ sulfonium compounds, bis-arene iron complexes; f) Bronsted acid compounds, such as pentafluoroantimonic acid complexes; and, e) mixtures of the aforementioned acids and acid esters; ii) tertiary amines, such as 1,4-diazabicyclo[2.2.2]octane, benzyldimethylamine, α-methylbenzyl dimethylamine, triethanolamine, dimethylamino propylamine, imidazoles—including N-methylimidazole, N-vinylimidazole and 1,2-dimethylimidazole—and salts of such tertiary amines; iii) quaternary ammonium salts, such as benzyltrimethyl ammonium chloride; iv) amidines, such as 1,8-diazabicyclo[5.4.0]undec-7-ene; v) guanidines, such as 1,1,3,3-tetramethylguanidine; vi) phenols, in particular bisphenols; vii) phenol resins; and, vii) phosphites, such as di- and triphenylphosphites.

In an embodiment, an amine catalyst for the curing a composition based on the epoxy resin may be photobase generator: upon exposure to UV radiation—typically in the wavelength from 320 to 420 nm—said photobase generator releases an amine, which catalyzes the addition of the epoxide reactive groups to the epoxide. The photobase generator is not specifically limited so long as it generates an amine directly or indirectly with light irradiation. However, suitable photobase generators which may be mentioned include: benzyl carbamates; benzoin carbamates; o-carbamoylhydroxyamines; O-carbamoyloximes; aromatic sulfonamides; alpha-lactams; N-(2-allylethenyl)amides; arylazide compounds, N-arylformamides, and 4-(ortho-nitrophenyl)dihydropyridines.

In an alternative embodiment, an acid catalyst may be selected from photoacid generators (PAGs): upon irradiation with light energy, ionic photoacid generators undergo a fragmentation reaction and release one or more molecules of Lewis or Bronsted acid that catalyze the ring opening and addition of the pendent epoxide groups to form a crosslink. Useful photoacid generators are thermally stable, do not undergo thermally induced reactions with the forming copolymer and are readily dissolved or dispersed in the curable compositions.

Exemplary cations which may be used as the cationic portion of the ionic PAG of the invention include organic onium cations such as those described in U.S. Pat. Nos. 4,250,311, 3,113,708, 4,069,055, 4,216,288, 5,084,586, 5,124,417, and, U.S. Pat. No. 5,554,664. The references specifically encompass aliphatic or aromatic Group IVA and VIIA (CAS version) centered onium salts, with a preference being noted for I-, S-, P-, Se- N- and C-centered onium salts, such as those selected from sulfoxonium, iodonium, sulfonium, selenonium, pyridinium, carbonium and phosphonium.

As is known in the art, the nature of the counter-anion in the ionic photoacid generator (PAG) can influence the rate and extent of cationic addition polymerization of the epoxide groups. For illustration, the order of reactivity among commonly used nucleophilic anions is SbF₆>AsF₆>PF₆>BF₄. The influence of the anion on reactivity has been ascribed to three principle factors which the skilled artisan should compensate for in the present invention: (1) the acidity of the protonic or Lewis acid generated; (2) the degree of ion-pair separation in the propagating cationic chain; and, (3) the susceptibility of the anions to fluoride abstraction and consequent chain termination.

It is not precluded that the compositions of the present invention include alternative photoinitiator compounds to the photobase generator and photoacid generator compounds mentioned herein above, which photoinitiator compound(s) would initiate the polymerization or hardening of the compositions upon irradiation with actinic radiation. It is noted that photo-polymerizable compositions of the present invention can be cationically polymerizable or free-radically polymerizable: whilst epoxy groups are cationically active, the election of a free-radical polymerization mechanism imposes the requirement that the composition must contain a compound possessing a free-radically active, unsaturated group such as an acrylate compound, a (meth)acrylate compound, an epoxy-functional acrylate, an epoxy functional (meth)acrylate or a combination thereof. Applying that election, the preferred photoinitiators would be photoactive compounds that undergo a Norrish I cleavage to generate free radicals that can initiate by addition to the acrylic double bonds.

In toto photoinitiators should be present in the composition in amount of from 0 to 1.0 wt. %, based on the weight of the composition.

The use of a photoinitiator—and also the photobase generator and photoacid generators mentioned herein above—may produce residue compounds from the photochemical reaction. The residues may be detected by conventional analytical techniques such as: infrared, ultraviolet and NMR spectroscopy; gas or liquid chromatography; and mass spectroscopy. Thus, the present invention may comprise cured (epoxy) matrix copolymers and detectable amounts of residues from a photobase/acid generator. Such residues are present in small amounts and do not normally interfere with the desired physiochemical properties of the product.

Without intention to limit the present invention, a mixture comprising one or more photoinitiators may be irradiated with activating radiation to polymerize the monomeric component(s). The purpose of the irradiation is to generate the active species from the photoinitiator which initiates the cure reactions. Once that species is generated, the cure chemistry is subject to the same rules of thermodynamics as any chemical reaction: the reaction rate may be accelerated by heat. The practice of using thermal treatments to enhance the cationic UV cure of monomers is generally known in the art, with an illustrative instructive reference being Crivello et al., “Dual Photo- and thermally initiated cationic polymerization of epoxy monomers,” Journal of Polymer Science A, Polymer Chemistry., Vol. 44, Issue: 23, pp. 6750-6764, (Dec. 1, 2006).

As would be recognized by the skilled artisan, photosensitizers can be incorporated into the compositions to improve the efficiency with which any photoinitiators present use the energy delivered. Photosensitizers are typically used in an amount of from 5 to 25 wt. %, based on the weight of the photoinitiator.

A “plasticizer” for the purposes of this invention is a substance that decreases the viscosity of the composition and thus facilitates its processability. Herein the plasticizer may constitute up to 10 wt. % or up to 5 wt. %, based on the total weight of the composition, and is preferably selected from the group consisting of: polydimethylsiloxanes (PDMS); diurethanes; ethers of monofunctional, linear or branched C4-C16 alcohols, such as Cetiol OE (obtainable from Cognis Deutschland GmbH, Düsseldorf); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; epoxidized plasticizers; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not preferred due to their toxicological potential. It is preferred that the plasticizer comprises or consists of one or more polydimethylsiloxane (PDMS).

“Stabilizers” for purposes of this invention are to be understood as antioxidants, UV stabilizers or hydrolysis stabilizers. Herein stabilizers may constitute in toto from 0 to 10 wt. % or up to 5 wt. %, based on the total weight of the composition. Standard commercial examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphorus; sulfur; and mixtures thereof.

As noted, the compositions according to the present invention can additionally contain fillers. Suitable here are, for example, chalk, lime powder, precipitated and/or pyrogenic silicic acid, zeolites, bentonites, magnesium carbonate, diatomite, alumina, clay, talc, titanium oxide, iron oxide, zinc oxide, sand, quartz, flint, mica, glass powder, and other ground mineral substances. Organic fillers can also be used, in particular carbon black, graphite, wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added. Aluminum powder is likewise suitable as a filler.

The pyrogenic and/or precipitated silica may advantageously have a BET surface area from 10 to 90 m²/g: when they are used, such silicas do not cause any additional increase in the viscosity of the composition according to the present invention but do contribute to strengthening the cured composition. It is likewise conceivable to use pyrogenic and/or precipitated silicic acids having a higher BET surface area, advantageously from 100 to 250 m²/g, in particular from 110 to 170 m²/g, as a filler: because of the greater BET surface area, the effect of strengthening the cured composition is achieved with a smaller proportion by weight of silica.

Also suitable as fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of 1 mm or less, preferably 500 μm or less.

Fillers which impart thixotropy to the composition may be preferred for many applications: such fillers are also described as rheological adjuvants, e.g. hydrogenated castor oil, fatty acid amides, or swellable plastics such as PVC.

The total amount of fillers present in the compositions of the present invention will preferably be from 0 to 30 wt. %, and more preferably from 0 to 20 wt. %, based on the total weight of the composition. The desired viscosity of the curable composition will typically be determinative of the total amount of filler added and it is submitted that in order to be readily extrudable out of a suitable dispensing apparatus—such as a tube—the curable compositions should possess a viscosity of from 3000 to 150,000, preferably from 40,000 to 80,000 mPas, or even from 50,000 to 60,000 mPas.

Having regard to component c) hereinabove, it is noted that other compounds having metal chelating properties may also be used in the compositions of the present invention to help enhance the adhesion of the cured adhesive to a substrate surface. Further, also suitable for use as adhesion promoters are the acetoacetate-functionalized modifying resins sold by King Industries under the trade name K-FLEX XM-B301.

In order to enhance shelf life even further, it is often advisable to further stabilize the compositions of the present invention with respect to moisture penetration through using drying agents. A need also occasionally exists to lower the viscosity of an adhesive or sealant composition according to the present invention for specific applications, by using reactive diluent(s). The total amount of reactive diluents present will typically be up to 15 wt. %, and preferably from 1 to 5 wt. %, based on the total weight of the composition.

The presence of non-reactive diluents in the compositions of the present invention is also not precluded where this can usefully moderate the viscosities thereof. For instance, but for illustration only, the compositions may contain one or more of: xylene; 2-methoxyethanol; dimethoxyethanol; 2-ethoxyethanol; 2-propoxyethanol; 2-isopropoxyethanol; 2-butoxyethanol; 2-phenoxyethanol; 2-benzyloxyethanol; benzyl alcohol; ethylene glycol; ethylene glycol dimethyl ether; ethylene glycol diethyl ether; ethylene glycol dibutyl ether; ethylene glycol diphenyl ether; diethylene glycol; diethylene glycol-monomethyl ether; diethylene glycol-monoethyl ether; diethylene glycol-mono-n-butyl ether; diethylene glycol dimethyl ether; diethylene glycol diethyl ether; diethylene glycoldi-n-butylyl ether; propylene glycol butyl ether; propylene glycol phenyl ether; dipropylene glycol; dipropylene glycol monomethyl ether; dipropylene glycol dimethyl ether; dipropylene glycoldi-n-butyl ether; N-methylpyrrolidone; diphenylmethane; diisopropylnaphthalene; petroleum fractions such as Solvesso® products (available from Exxon); alkylphenols, such as tert-butylphenol, nonylphenol, dodecylphenol and 8,11,14-pentadecatrienylphenol; styrenated phenol; bisphenols; aromatic hydrocarbon resins especially those containing phenol groups, such as ethoxylated or propoxylated phenols; adipates; sebacates; phthalates; benzoates; organic phosphoric or sulfonic acid esters; and sulfonamides.

The above aside, it is preferred that said non-reactive diluents constitute less than 10 wt. %, in particular less than 5 wt. % or less than 2 wt. %, based on the total weight of the composition.

### Illustrative Embodiment of the Two Component Composition

In accordance with an illustrative embodiment of the invention, there is provided a two component (2K) composition comprising, based on the weight of the composition:
(I) a first component comprising:
   from 0.5 to 4 wt. % of a) at least one epoxy silane oligomer according to Formula (AII):

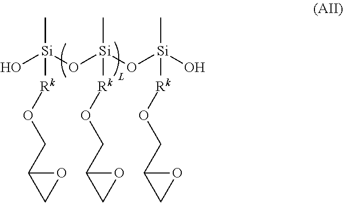

wherein: L is an integer of from 1 to 10; and,
   R^{k} is C₁-C₄ alkyl;
from 15 to 75 wt. % of b) at least one polyepoxide compound having at least three epoxide groups per molecule, wherein said at least one polyepoxide is selected from the group consisting of: glycidyl ethers of polyhydric alcohols; glycidyl ethers of polyhydric phenols; glycidyl esters of polycarboxylic acids; polyfunctional glycidylamines; and epoxidized polyethylenically unsaturated hydrocarbons; and,
from 0 to 15 wt. % c) at least one compound selected from the group consisting of monoepoxide compounds and diepoxide compounds;
wherein the compounds of part b) and part c) do not meet Formula (AI); (II) a second component comprising:
from 15 to 30 wt. % of d) a curative consisting of at least two compounds possessing at least two epoxide reactive groups per molecule, said curative being characterized by comprising: at least one phenalkamine; and, at least one cycloaliphatic amine selected from the group consisting of: 1,2-, 1,3- and 1,4-diaminocyclohexane; bis(4-aminocyclohexyl)methane; bis(4-amino-3-methylcyclohexyl)methane; bis(4-amino-3-ethylcyclohexyl)methane; bis(4-amino-3,5-dimethylcyclohexyl)methane; bis(4-amino-3-ethyl-5-methylcyclohexyl)methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)-cyclohexane; 1,4-bis(aminomethyl)cyclohexane; 2,5(2,6)-bis(aminomethyl)-bicyclo[2.2.1]heptane (norborane diamine, NBDA); 3(4),8(9)-bis(aminomethyl)tricyclo[5.2.1.02,6]-decane (TCD-diamine); 1,4-diamino-2,2,6-trimethylcyclohexane (TMCDA); N,N-bis(3-aminopropyl)cyclohexylamine; and, 1,8-menthanediamine,
   wherein the two component (2K) composition further comprises:
e) core-shell rubber particles of which at least a portion are provided in the first component (I); and,
   wherein the two component (2K) composition is further characterized by a molar ratio of epoxide-reactive groups to epoxide groups of from 0.95:1 to 1.1:1.

### Methods and Applications

For the two component (2K) curable compositions, the reactive components are brought together and mixed in such a manner as to induce the hardening thereof: the reactive compounds should be mixed under sufficient shear forces to yield a homogeneous mixture. It is considered that this can be achieved without special conditions or special equipment. That said, suitable mixing devices might include: static mixing devices; magnetic stir bar apparatuses; wire whisk devices; augers; batch mixers; planetary mixers; C.W. Brabender or Banburry® style mixers; and, high shear mixers, such as blade-style blenders and rotary impellers.

For small-scale liner applications in which volumes of less than 2 liters will generally be used, the preferred packaging for the two component (2K) compositions will be side-by-side double cartridges or coaxial cartridges, in which two tubular chambers are arranged alongside one another or inside one another and are sealed with pistons: the driving of these pistons allows the components to be extruded from the cartridge, advantageously through a closely mounted static or dynamic mixer. For larger volume applications, the two components of the composition may advantageously be stored in drums or pails: in this case the two components are extruded via hydraulic presses, in particular by way of follower plates, and are supplied via pipelines to a mixing apparatus which can ensure fine and highly homogeneous mixing of the hardener and binder components. In any event, for any package it is important that the binder component be disposed with an airtight and moisture-tight seal, so that both components can be stored for a long time, ideally for 12 months or longer.

Non-limiting examples of two component dispensing apparatuses and methods that may be suitable for the present invention include those described in U.S. Pat. Nos. 6,129,244 and 8,313,006.

The two (2K) component curable compositions should broadly be formulated to exhibit an initial viscosity—determined immediately after mixing, for example, up to two minutes after mixing—of less than 200000 mPa-s, for instance less than 100000 mPa·s, at 25° C. Independently of or additional to said viscosity characteristics, the two (2K) component composition should be formulated to be bubble (foam) free upon mixing and subsequent curing. Moreover, the two component (2K) composition should further be formulated to demonstrate at least one, desirably at least two and most desirably all of the following properties: i) a long pot life, typically of at least 30 minutes and commonly of at least 60 or 120 minutes, which pot life should be understood herein to be the time after which the viscosity of a mixture at 20° C. will have risen to more than 50,000 mPas; ii) a maximum exotherm temperature of no greater than 120° C., preferably no greater than 100° C. and more preferably no greater than 80° C.; and, iii) a Shore A hardness of at least 50, preferably at 60 and more preferably at least 70 after being cured and stored for 7 days at room temperature and 50% relative humidity.

The curing of the compositions of the invention typically occurs at temperatures in the range of from −10° C. to 120° C., preferably from 0° C. to 70° C., and in particular from 20° C. to 60° C. The temperature that is suitable depends on the specific compounds present and the desired curing rate and can be determined in the individual case by the skilled artisan, using simple preliminary tests if necessary. Of course, curing at temperatures of from 10° C. to 35° C. or from 20° C. to 30° C. is especially advantageous as it obviates the requirement to substantially heat or cool the mixture from the usually prevailing ambient temperature. Where applicable, however, the temperature of the mixture formed from the respective components of a two (2K) component composition may be raised above the mixing temperature and/or the application temperature using conventional means including microwave induction.

The curable compositions according to the invention may find utility inter alia in: varnishes; inks; binding agents for fibers and/or particles; the coating of glass; the coating of mineral building materials, such as lime- and/or cement-bonded plasters, gypsum-containing surfaces, fiber cement building materials and concrete; the coating and sealing of wood and wooden materials, such as chipboard, fiber board and paper; the coating of metallic surfaces; the coating of asphalt- and bitumen-containing pavements; the coating and sealing of various plastic surfaces; and, the coating of leather and textiles.

By virtue of the fact that the compositions of the present invention are capable of creating a high binding strength in a short time, often at room temperature, the compositions are optimally used for forming composite structures by surface-to-surface bonding of the same or different materials to one another. The binding together of wood and wooden materials and the binding together of metallic materials may be mentioned as exemplary adhesive applications of the present compositions.

It is also considered that the compositions of the present invention are suitable as pourable sealing compounds for electrical building components such as cables, fiber optics, cover strips or plugs. The sealants may serve to protect those components against the ingress of water and other contaminants, against heat exposure, temperature fluctuation and thermal shock, and against mechanical damage.

In a particularly preferred embodiment, the composition of the present invention is employed an adhesive or sealant for shaped and jointed metallic components such as those found in vehicles and, in particular, the doors, trunks, hood shields and panels of automobiles. A sealant may be employed during either the manufacture or the repair of such components and will effectively serve the functions of sealing those components and preventing the corrosion thereof.

In each of the above described applications, the compositions may applied by conventional application methods such as: brushing; roll coating using, for example, a 4-application roll equipment where the composition is solvent-free or a 2-application roll equipment for solvent-containing compositions; doctor-blade application; printing methods; and, spraying methods, including but not limited to air-atomized spray, air-assisted spray, airless spray and high-volume low-pressure spray. For coating and adhesive applications, it is recommended that the compositions be applied to a wet film thickness of from 10 to 500 μm. The application of thinner layers within this range is more economical and provides for a reduced likelihood of thick cured regions that may—for coating applications—require sanding. However, great control must be exercised in applying thinner coatings or layers so as to avoid the formation of discontinuous cured films.

For completeness, it is noted that the present invention does not preclude the preparation of epoxy adhesives in the form of “film adhesive”. A pre-polymer mixture of epoxy resins, hardener, and other desired components is applied as a coating onto a polymer film substrate, rolled up and stored at a sufficiently low temperature to inhibit the chemical reactions between the components. When needed, the film adhesive is removed from the low temperature environment and applied to a metal or composite part, the backing is stripped off and the assembly completed and cured in an oven or autoclave.

The following examples are illustrative of the present invention and are not intended to limit the scope of the invention in any way.

### EXAMPLES

The following materials were employed in the Examples:
Kane Ace 414: N,N,N′,N′-tetraglycidyl-4,4′-methylenebisbenzeneamine based epoxy resin (75 wt. %) in which is dispersed core-shell beads (25 wt. %), available from Kaneka Corporation.
Kane Ace 154: Bisphenol A epoxy resin (60 wt. %) in which is dispersed core-shell beads (40 wt. %), available from Kaneka Corporation.
CoatOSil MP 200: Multifunctional epoxy resin silane oligomer, available from Momentive Performance.
Ancamine 2264: Modified cycloaliphatic amine curing agent, available from Evonik Industries AG.
Acamine 2914 UF: Aliphatic curing agent containing accelerator, available from Evonik Industries AG.
Cardolite NX 5608: Phenalkamine curing agent, available from Cardolite Corporation.
SHOFREE BATG: Multifunctional epoxy resin, (2,2′-[1-methylethylidene)bis[6-(2-oxiranylmethoxy)-3,1-phenylne)methylene]]bis-oxirane (CAS No. 1799411-80-5), available from Showa Denko.
Loctite PC 7303: Two component high temperature resistant epoxy wearing compound, available from Henkel.

First and second components of exemplary curable composition were prepared by simple mixing of the constituents listed in Table 1 below. For completes, the percentages by weight in Table 1 are of the composition in toto and not of the individual components thereof.

TABLE 1

| | | | | Compar- |
|---|---|---|---|---|
| | | | | ative |
| | Example | Example | Example | Example |
| Ingredient | 1 | 2 | 3 | 1 |
| 1^{st} Component | | | | |
| Kane Ace 414 | 68.6 | 68.6 | | |
| Kane Ace 154 | | | 45.0 | |
| CoatOSil MP 200 | 1.4 | 1.4 | 1.5 | |
| SHOFREE BATG | | | 28.5 | |
| Loctite PC 7303 Resin | | | | 80.0 |
| 2^{nd} Component | | | | |
| Ancamine 2264 | 19.5 | 18.0 | 15.0 | |
| Ancamine 2914 UF | | 6.0 | 5.0 | |
| Cardolite NX 5608 | 10.5 | 6.0 | 5.0 | |
| Loctite PC 7303 | | | | 20.0 |
| Hardener | | | | |

To form the curable composition, the two tabulated components of each Example are combined. The following test was then performed to characterize each composition.

Initial Bond Strength, Tensile Lap Shear (TLS) Test: The substrate tested was stainless steel (1.4301, thickness 1.5 mm). The substrate was cut into 2.5 cm×10 cm plates for tensile testing. The bond overlapping area for each plate was 2.5 cm×1.0 cm (1″×0.4″) with a bond thickness of 150 microns. For the initial bonding operation, the applied adhesive compositions were cured in the overlapping region at 23° C. for 168 hours. Loctite PC 7303, the comparative example, was additionally cured at 148° C. for 2 hours. Tensile lap shear (TLS) tests were then performed at 23° C., 150° C. and 200° C. based upon EN 1465:2009 (German version) Adhesives—Determination of Tensile Lap-shear Strength of Bonded Assemblies. The test specimens were placed in the grips of a universal testing machine and pulled at 10 mm/min until failure occurs. The grips used to secure the ends of the assembly were aligned so that the applied force was applied through the centerline of the specimen. The type of failure observed could be either adhesive—wherein the adhesive separates from one of the substrates—or cohesive wherein the adhesive ruptures within itself. The results of this test are provided in Table 2 below.

TABLE 2

| | | | | Comparative |
|---|---|---|---|---|
| Lap Shear | Example 1 | Example 2 | Example 3 | Example 1 |
| Condition | (MPa) | (MPa) | (MPa) | (MPa) |
| 23° C. | 21.7 | 25.5 | 27.8 | 12.6 |
| 150° C. | 6.7 | 7.0 | 8.8 | 1.6 |
| 200° C. | 7.3 | 6.8 | 6.8 | 1.3 |

In view of the foregoing description and examples, it will be apparent to those skilled in the art that equivalent modifications thereof can be made without departing from the scope of the appended claims.

1. A two component (2K) composition comprising:
(1) a first component comprising:
a) at least one epoxy silane oligomer according to Formula (AI): 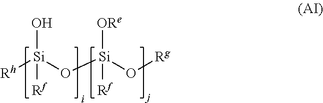
wherein: R^{e} is a C₁-C₆ alkyl group;
R^{f} is an epoxide substituted C₁-C₁₂ alkyl group, C₃-C₁₈ cycloalkyl group or C₂-C₁₈ alkoxyalkyl group;
R^{g} is H or a C₁-C₆ alkyl group;
R^{h} is a C₁-C₆ alkyl group;
i is an integer≥1; and,
j is an integer≥1;
b) at least one polyepoxide compound having at least three epoxide groups per molecule; and,
optionally c) at least one compound selected from the group consisting of monoepoxide compounds and diepoxide compounds;
wherein the compounds of part b) and part c) do not meet Formula (AI);
(II) a second component comprising:
d) a curative consisting of at least two compounds possessing at least two epoxide reactive groups per molecule, said curative being characterized by comprising: at least one Mannich base; and at least one cycloaliphatic amine,
wherein the two component (2K) composition further comprises:
e) core shell rubber particles; and,
wherein the two component (2K) composition is further characterized by a molar ratio of epoxide-reactive groups to epoxide groups of from 0.95:1 to 1.5:1.

2. The two component (2K) composition according to claim 1 comprising, based on the weight of the composition:
from 0.1 to 5 wt. % of a) said at least one epoxy silane oligomer according to Formula (AI);
from 10 to 80 wt. % of b) said at least one polyepoxide compound having at least three epoxide groups per molecule;
from 0 to 20 wt. % of c) said at least one at least one compound selected from the group consisting of monoepoxide compounds and diepoxide compounds;
from 10 to 30 wt. % of d) said curative; and,
from 5 to 30 wt. % of e) said core shell rubber particles,
wherein the two component (2K) composition is further characterized by a molar ratio of epoxide-reactive groups to epoxide groups of from 0.95:1 to 1.1:1.

3. The two component (2K) composition according to claim 1 comprising, based on the weight of the composition:
from 0.5 to 4 wt % of a) said at least one epoxy silane oligomer according to Formula (AI);
from 15 to 75 wt. % of b) said at least polyepoxide compound having at least three epoxide groups per molecule;
from 0 to 15 wt. % of c) said at least one at least one compound selected from the group consisting of monoepoxide compounds and diepoxide compounds;
from 10 to 30 wt. % of d) said curative; and,
from 5 to 25 wt. % of e) said core shell rubber particles,
wherein the two component (2K) composition is further characterized by a molar ratio of epoxide-reactive groups to epoxide groups of from 0.95:1 to 1.1:1.

4. The two component (2K) composition according to claim 1, wherein a) said at least one epoxy silane oligomer is characterized by a number average molecular weight (Mn) of from 200 to 3000 daltons.

5. The two component (2K) composition according to claim 1, wherein part a) of the composition comprises or consists of at least one compound in accordance with Formula (AII): 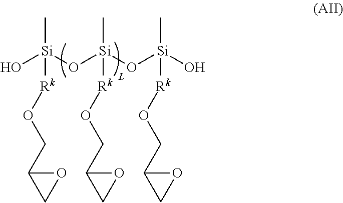
wherein: L is an integer of from 0 to 20; and,
R^{k} is C₁-C₆ alkyl.

6. The two component (2K) composition according to claim 5, wherein: L is an integer of from 1 to 10; and R^{k} is C₁-C₄ alkyl.

7. The two component (2K) composition according to claim 1, wherein b) said at least one polyepoxide compound having at least three epoxide groups per molecule is selected from the group consisting of: glycidyl ethers of polyhydric alcohols; glycidyl ethers of polyhydric phenols; glycidyl esters of polycarboxylic acids; polyfunctional glycidylamines; and epoxidized polyethylenically unsaturated hydrocarbons.

8. The two component (2K) composition according to claim 1, wherein part b) comprises at least one polyfunctional glycidylamine selected from the group consisting of: N,N,N′,N′-tetraglycidyl-4,4′methylene bisbenzenamine; p-aminophenol triglycidyl ether; m-aminophenol triglycidyl ether; tetraglycidyl bis(aminomethyl)cyclohexane; and N,N,N′,N′-tetraglycidyl-m-xylenediamine.

9. The two component (2K) composition according to claim 1, wherein part c) comprises at least one diepoxide compound having an epoxide equivalent weight of from 100 to 700 g/eq.

10. The two component composition according to claim 9, wherein said least one diepoxide compound is selected from the group consisting of: glycidyl ethers of diyhydric alcohols; glycidyl ethers of dihydric phenols; glycidyl esters of dicarboxylic acids; and, epoxidized polyethylenically unsaturated hydrocarbons.

11. The two component (2K) composition according to claim 1, wherein the Mannich base of the curative is a phenalkamine.

12. The two component (2K) composition according to claim 1, wherein the cycloaliphatic amine of the curative is selected from the group consisting of: 1,2-, 1,3- and 1,4-diaminocyclohexane; bis(4-aminocyclohexyl)methane; bis(4-amino-3-methylcyclohexyl)methane; bis(4-amino-3-ethylcyclohexyl)methane; bis(4-amino-3,5-dimethylcyclohexyl)methane; bis(4-amino-3-ethyl-5-methylcyclohexyl)methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)-cyclohexane; 1,4-bis(aminomethyl)cyclohexane; 2,5(2,6)-bis(aminomethyl)-bicyclo[2.2.1]heptane (norborane diamine, NBDA); 3(4),8(9)-bis(aminomethyl)tricyclo[5.2.1.02,6]-decane (TCD-diamine); 1,4-diamino-2,2,6-trimethylcyclohexane (TMCDA); N,N-bis(3-aminopropyl)cyclohexylamine; and, 1,8-menthanediamine.

13. The two component (2K) composition according to claim 1, wherein at least a portion of the core shell rubber particles are provided in the first component of the composition.

14. A cured product obtained from the two component (2K) composition as defined in claim 1.
